(19) United States
(12) Patent Application Publication
(10) Pub. No.: US 2026/0044653 A1
(43) Pub. Date: Feb. 12, 2026

(54) METHOD AND APPARATUS FOR EVOLVING SIMULATION MODEL FOR TURBINE DEVICE, MEDIUM, AND COMPUTING DEVICE

(71) Applicant: Nuclear Power Institute of China, Chengdu (CN)

(72) Inventors: Liqin ZHANG, Chengdu (CN); Yanping HUANG, Chengdu (CN); Xiaokang ZENG, Chengdu (CN); Houjun GONG, Chengdu (CN); Wenbin ZHUO, Chengdu (CN)

(73) Assignee: Nuclear Power Institute of China, Chengdu (CN)

(21) Appl. No.: 19/364,275

(22) Filed: Oct. 21, 2025

Related U.S. Application Data
(63) Continuation of application No. PCT/CN2024/124137, filed on Oct. 11, 2024.

(30) Foreign Application Priority Data
Jan. 3, 2024 (CN) 202410004544.9

(51) Int. Cl. G06F 30/27; G06F 113/06

(52) U.S. Cl. CPC G06F 30/27; G06F 2113/06

(57) ABSTRACT

A method for evolving a simulation model for a turbine device includes: acquiring current operation data of the turbine device with an inlet parameter as a design parameter; pre-checking the simulation model based on the current operation data; preprocessing the current operation data to obtain a combined dataset when a result of the pre-check indicates that the simulation model requires evolution, the combined dataset including input data and output data corresponding to the input data; constructing a mapping model based on the combined dataset and outputting, using the mapping model, an updated performance curve of the turbine device with the inlet parameter as the design parameter; and replacing a previous performance curve of the simulation model with the updated performance curve to evolve the simulation model.

### CROSS-REFERENCE TO RELATED APPLICATIONS

The present application is a continuation application of International Application No. PCT/CN2024/124137, filed on Oct. 11, 2024, which claims priority to Chinese Patent Application No. 202410004544.9, filed on Jan. 3, 2024. All of the aforementioned applications are incorporated herein by reference in their entireties.

### TECHNICAL FIELD

The present application relates to the technical field of device simulation, and in particular, to a method and an apparatus for evolving a simulation model for a turbine device, a medium, and a computing device.

### BACKGROUND

The turbine device is a device in which a turbine component is driven to rotate by fluid impinging on the turbine component itself to generate kinetic energy. The turbine device is widely applied in various fields of energy and electric power, and is a core part of a power generation system or power system. The operating characteristics of the turbine device directly affect the system performance of the power generation system or power system in which it is located, and therefore it is necessary to predict the operating characteristics of the turbine device.

In order to facilitate the prediction of the operating characteristics of the turbine device, the method disclosed in the prior art is to construct a simulation model based on a turbine device in actual operation, simulate the operation of the turbine device through the simulation model, and generate the operating characteristics of the corresponding turbine device. However, in the actual operation, there is a deviation between the operating characteristics of the turbine device outputted by the simulation model and the actual operating characteristics of the turbine device.

### SUMMARY

A main objective of the present application is to provide a method and an apparatus for evolving a simulation model for a turbine device, a medium, and a computing device, to solve a technical problem that a deviation exists between operating characteristics of the turbine device output by a simulation model and actual operating characteristics of the turbine device.

To achieve the foregoing objective, a first aspect of the present application provides a method for evolving a simulation model for a turbine device. The method includes: acquiring current operation data of the turbine device with an inlet parameter as a design parameter; pre-checking the simulation model based on the current operation data; preprocessing the current operation data to obtain a combined dataset when a result of the pre-check indicates that the simulation model requires evolution, the combined dataset including input data and output data corresponding to the input data; constructing a mapping model based on the combined dataset and outputting, using the mapping model, an updated performance curve of the turbine device with the inlet parameter as the design parameter; and replacing a previous performance curve of the simulation model with the updated performance curve to evolve the simulation model.

In an embodiment, the current operation data includes at least flow ratio data, rotational speed ratio data, pressure ratio data, and efficiency data of the turbine device at a current stage; and wherein the preprocessing the current operation data to obtain a combined dataset includes: classifying the current operation data into an input dataset and an output dataset, the input dataset including the flow ratio data and the rotational speed ratio data, and the output dataset including the pressure ratio data and the efficiency data; and mapping data in the input dataset with data in the output dataset to obtain the combined dataset.

In an embodiment, the combined data set includes a training set and a test set, and the constructing a mapping model based on the combined data set includes: training a selected machine learning model using the combined dataset to obtain the mapping model, wherein input parameters of the mapping model correspond to data types in the input dataset, and output parameters of the mapping model correspond to data types in the output dataset.

In an embodiment, the training the selected machine learning model using the combined data set to obtain a mapping model includes: dividing the combined data set into a training set and a test set; training the selected machine learning model using the training set; testing the trained machine learning model using the test set, where the machine learning model outputs corresponding test output data based on input data in the test set; and determining the machine learning model as the mapping model if a test result indicates that an output accuracy of the machine learning model meets a preset condition.

In an embodiment, testing the trained machine learning model using the test set includes: determining an absolute value of an accuracy error between the test output data and original output data corresponding to the input data in the test set; and comparing the absolute value of the accuracy error with a second preset threshold.

In an embodiment, the preset condition includes the absolute value of the accuracy error between the test output data and the original output data being less than the second preset threshold.

In an embodiment, if test result indicates that the output accuracy of the machine learning model does not meet the preset condition, the method further includes: selecting a different machine learning model; training the different machine learning model using the training set; and testing the trained different machine learning model using the test set, where the selecting to testing are repeated until the test result satisfies the preset condition.

In an embodiment, the pre-checking the simulation model based on the current operation data includes: constructing a current operation curve of the turbine device based on the current operation data; comparing the current operation curve with the previous performance curve of the simulation model; comparing a difference between the previous performance curve and the current operation curve with a first preset threshold, wherein the first preset threshold is determined based on a precision requirement set by a user; determining that the simulation model requires evolution when the difference exceeds the first preset threshold; and determining that the simulation model does not require evolution when the difference is less than or equal to the first preset threshold.

In an embodiment, before the classifying the current running data, the method further includes: cleaning the current operating data to remove abnormal data.

In addition, to achieve the foregoing objective, an embodiment of the present application further provides an apparatus for evolving a simulation model for a turbine device. The apparatus includes: a data acquisition unit configured to acquire current operation data of the turbine device with an inlet parameter as a design parameter; a pre-check unit configured to pre-check the simulation model based on the current operation data; a preprocessing unit configured to preprocess the current operation data to obtain a combined dataset when a result of the pre-check indicates that the simulation model requires evolution, wherein the combined dataset includes input data and output data corresponding to the input data; a model construction unit configured to construct a mapping model based on the combined dataset and outputting, using the mapping model, an updated performance curve of the turbine device with the inlet parameter as the design parameter; and an evolution unit configured to evolve the simulation model by replacing a previous performance curve of the simulation model with the updated performance curve.

In addition, to achieve the foregoing objective, an embodiment of the present application further provides a computer-readable storage medium storing instructions which, when executed by a computer, cause the computer to perform the method as described above.

In addition, to achieve the foregoing objective, an embodiment of the present application further provides a computing device, where the computing device includes at least one processor, a memory, and an input/output unit. The memory stores instructions that, when executed by the at least one processor, cause the computing device to perform the method as described above.

According to the method for evolving a simulation model for a turbine device according to the embodiments of the present application, the current operation data of the turbine device is acquired firstly, and the current operation data represents the actual operating characteristics of the turbine device in the current state. The current operation data is then divided into an input dataset and an output dataset. The data in the input dataset and data in the output dataset are subsequently combined to generate a combined dataset, the combined dataset is input into a sample library, and a machine learning model is used to perform model training based on the combined dataset in the sample library to generate a mapping model. An updated performance curve is generated by the mapping model, the updated performance curve reflecting the pressure ratio and efficiency of the turbine device under different flow ratio and speed ratio conditions in the current state. Finally, the previous performance curve of the simulation model is replaced with the updated performance curve generated by the mapping model, so that the simulation model can evolve according to the degree of degradation of the turbine device, and truly reflect the operating characteristics of the turbine device at different life cycle stages.

### BRIEF DESCRIPTION OF THE DRAWINGS

FIG. 1 is a schematic flowchart of a method for evolving a simulation model for a turbine device according to an embodiment of the present application.

FIG. 2 is a performance curve of flow ratio-efficiency of a simulation model according to an embodiment of the present application.

FIG. 3 is a performance curve of a flow ratio-pressure ratio of a simulation model according to an embodiment of the present application.

FIG. 4 is a structural block diagram of an apparatus for evolving a simulation model for a turbine device according to an embodiment of the present application.

FIG. 5 is a schematic structural diagram of a medium according to an embodiment of the present application.

FIG. 6 is a schematic structural diagram of a computing device according to an embodiment of the present application.

Implementations, functional features, and advantages of the present disclosure will be further described with reference to the accompanying drawings in combination with the embodiments.

### DETAILED DESCRIPTION OF THE EMBODIMENTS

It should be understood that the specific embodiments described herein are only used to explain the present disclosure and are not intended to limit the present disclosure.

During the entire lifecycle of the turbine device, components inevitably undergo wear and degradation. The performance curve output by turbine simulation models is derived from theoretical calculations representing the operating characteristics of the turbine device under ideal conditions. Therefore, a significant discrepancy exists between the actual operating characteristics of degraded turbine device and the operating characteristics represented by the performance curve output by the simulation model. In other words, the performance curve generated by the turbine simulation model fails to accurately represent the actual operating characteristics of the turbine device.

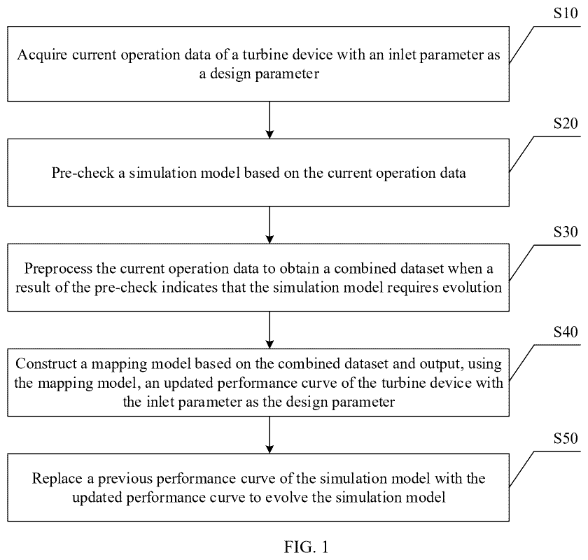

Referring to FIG. 1, to resolve the foregoing technical problem, an embodiment of the present application provides a method for evolving a simulation model for a turbine device. The method may be performed by a computing device, and the computing device may be, for example, a server or a computer. The method provided in the present application may include the following steps S10 to S50.

In S10, current operation data of the turbine device is acquired, with an inlet parameter as a design parameter.

The current operation data refers to outlet temperature, pressure, and flow rate of the turbine device corresponding to various inlet conditions at the current operational stage, including different inlet temperatures, pressures, flow rates, and rotational speeds.

The inlet parameter of the turbine device may include inlet mass flow rate, inlet total pressure, inlet total temperature, and inlet dynamic and static pressure differences.

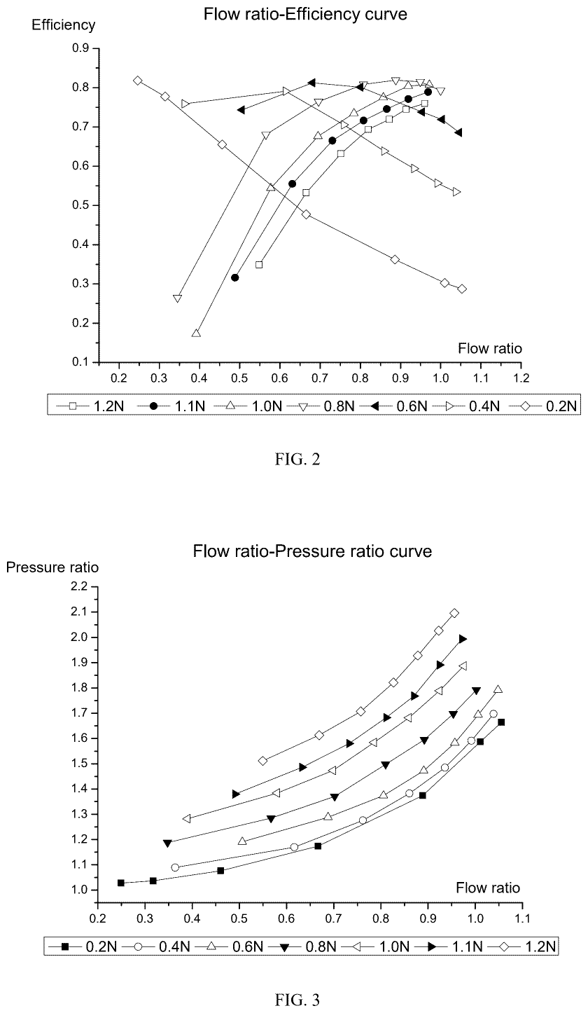

It should be noted that the obtained current operation data should cover the entire rotational speed range and flow rate range of the turbine device to ensure the comprehensiveness of the operation data. The entire rotational speed range of the turbine device refers to the range from the minimum rotational speed up to the permissible overspeed limit. The flow rate range refers to the range from the surge-safe flow rate to the choke-safe flow rate at each rotational speed. Referring to FIG. 2 and FIG. 3, the entire rotational speed range of the turbine device is from 0.2 N to 1.2 N. The flow rate range is obtained by multiplying the flow rate ratio by the rated flow rate. For example, at a rated speed of 1.0 N, the flow rate range of the turbine device is from 0.39 to 0.97.

In this exemplary embodiment, the pressure ratio data and efficiency data of the turbine device at the current stage may be obtained by the following equations.

$${P}_{rt} = {P}_{t , in} / {P}_{t , out}$$

$${η}_{t} = Δ h / Δ {h}_{0}$$

Pᵣₜ is the pressure ratio of the turbine device; P_{t,in} is the inlet pressure of the turbine device, P_{t,out} is the outlet pressure of the turbine device; ηₜ is the efficiency of the turbine device, Δh is the actual enthalpy difference between the inlet and the outlet of the turbine device, and Δh0 is the isentropic enthalpy difference between the inlet and outlet of the turbine device.

In S20, the simulation model is pre-checked based on the current operation data.

The simulation model is pre-checked based on the current operation data, to determine whether the simulation precision of the simulation model matches the current performance of the turbine device, that is, to determine whether the turbine device simulation model needs to be evolved. It is understood that during operation, the turbine device inevitably experiences performance degradation, resulting in a shift of its characteristic curve. If the performance curve of the simulation model does not match the current performance of the turbine device, the simulation accuracy of the model will decrease. This step aims to conduct a preliminary verification of the simulation model, and when the verification result indicates that the simulation model requires evolution, subsequent steps are performed to eliminate the shift in the characteristics curve and the decline in simulation accuracy caused by performance degradation.

In an exemplary embodiment, step S20 may specifically include: constructing a current operation curve of the turbine device based on the current operation data; comparing the current operation curve with the previous performance curve of the simulation model; comparing a difference between the previous performance curve and the current operation curve with a first preset threshold, wherein the first preset threshold is determined based on a precision requirement set by a user; determining that the simulation model requires evolution when the difference exceeds the first preset threshold; and determining that the simulation model does not require evolution when the difference is less than or equal to the first preset threshold.

Specifically, the turbine device is provided with a dedicated “historical performance curve”, which may be updated according to the current operating stage of the turbine device. Each time the simulation model undergoes evolution, the performance curve of the turbine device obtained under the premise that the evolved inlet parameter correspond to the design parameter is saved as the latest “historical performance curve.” Every subsequent performance curve comparison is conducted against the latest historical performance curve. The “historical performance curve” of the first stage is the performance curve provided by the manufacturer and calibrated with the initial operation data of the unit.

It is understood that the current operation data is obtained under the condition that the inlet parameter of the turbine device corresponds to the inlet design parameter. Therefore, the current operation curve constructed based on the current operation data represents the operation curve under the premise that the inlet parameter corresponds to the inlet design parameter. The current operation curve may include a “flow ratio-pressure ratio curve” and a “flow ratio-efficiency curve.” Accordingly, this step involves comparing the historical operating “flow ratio-pressure ratio curve” and “flow ratio-efficiency curve” of the turbine device with the current operating “flow ratio-pressure ratio curve” and “flow ratio-efficiency curve,” respectively, while maintaining the inlet parameter as the inlet design parameter (i.e., inlet design temperature and inlet design pressure), to determine whether the deviation between the two exceeds a first preset threshold. When the deviation exceeds the first preset threshold, the simulation model is deemed to require evolution. Exemplarily, the current operation curve corresponding to the turbine device may be constructed based on the current operation data, and both the current operation curve and the historical performance curve of the simulation model may be plotted on the same graph, thereby visually obtaining the difference between the current operation data and the historical performance curve to facilitate intuitive determination of whether the simulation model requires evolution. The first preset threshold may be adjusted according to the required accuracy. The higher the accuracy requirement, the higher the frequency of turbine apparatus model updates. Conversely, the lower the accuracy requirement, the lower the update frequency of the model.

For example, taking a turbine as an example, a characteristics curve of the turbine is as shown in FIG. 2 and FIG. 3. Taking a first preset threshold of 10% as an example, at a design rotational speed of 1.0 N, when the maximum deviation between the current operation pressure ratio and efficiency of the turbine and the corresponding values on the historical curves exceeds 10%, it indicates that the simulation model requires evolution. The pressure ratio and the efficiency are calculated at the same flow ratio and the same rotational speed ratio. The maximum deviation is calculated as follows.

$$Err 1 \% = ( Pr - {Pr}_{0} ) / {Pr}_{0}$$

$$Err 2 \% = ( η - {η}_{0} ) / {η}_{0}$$

Err1 represents the difference in pressure ratio; Err2 represents the difference in efficiency; Pr represents the current pressure ratio; Pr₀ represents the historical pressure ratio; η represents the current efficiency; η₀ represents the historical efficiency, where Pr and η are obtained by differentiating the current operating data from the pressure ratio curve and efficiency curve at the design rotational speed of 1.0 N, and Pr₀ and η₀ are obtained by differentiating the historical performance curve from the pressure ratio curve and efficiency curve at the design rotational speed of 1.0 N.

In S30, the current operation data is preprocessed to obtain a combined dataset when a result of the pre-check indicates that the simulation model requires evolution, the combined dataset comprising input data and output data corresponding to the input data.

The pre-processing on the current operation data is to process the current operation data into input data and output data to establish a correspondence between the input data and the output data. Subsequently, a mapping model constructed in later steps is used to obtain an updated performance curve corresponding to the current operation data. The updated performance curve is employed to replace the historical performance curve in the simulation model.

In this exemplary embodiment, the current operation data may include a flow ratio, a rotational speed ratio, a pressure ratio, and an efficiency of the turbine device at the current stage. The flow ratio represents a ratio of a fluid output flow rate to a fluid input flow rate of the turbine device at the current stage. The rotational speed ratio represents a ratio of an operating rotational speed to a rated rotational speed of the turbine device at the current stage. The pressure ratio represents a ratio of a fluid pressure at an inlet of the turbine device to a fluid pressure at an outlet thereof at the current stage. The efficiency represents an operating speed of the turbine device in performing work at the current stage.

On this basis, step S30 may include: classifying the current operation data into an input dataset and an output dataset, the input dataset comprising the flow ratio data and the rotational speed ratio data, and the output dataset comprising the pressure ratio data and the efficiency data; and mapping data in the input dataset with data in the output dataset to obtain the combined dataset.

Specifically, the current operation data includes operating data of the turbine device acquired under different operating conditions. In order to facilitate subsequent fitting of the operating state of the turbine device, the current operation data may be classified divided into an input data set and an output data set. The input data set is used as the input parameter of the mapping model in the subsequent step, and the output data set is used as the output parameter of the mapping model in the subsequent step. The current operation data is divided into the input data set and the output data set, so that the subsequent fitting of the data of the turbine device in the current stage can be facilitated, and the efficiency of processing the data can also be improved.

The data in the input data set and the data in the output data set are correspondingly combined, that is, the mapping relationship between the data in the input data set and the data in the output data set is to be established, so as to obtain the combined data set. In other words, the combined data set indicates the output data output by the turbine device at the current input data, that is, the combined data set reflects the actual operating condition of the turbine device in the current stage. By obtaining the input data set and the corresponding output data set, the mapping relationship of the turbine device in the current operating condition can be obtained, thereby facilitating accurate acquisition of the operating state of the current turbine device.

In an exemplary embodiment, a data processing model may be established. The data processing model processes the current operation data of the turbine device into a combination of the input data set and the input data set to obtain the combined data set, and the combined data set constitutes a sample library of the machine learning model in subsequent steps. The data processing model may automatically, in a one-click manner, screen from the combined data set the pressure ratio data and efficiency data corresponding to different flow ratio data and rotational speed ratio data under a design inlet pressure and a design inlet temperature, so as to form the sample library for machine learning.

In an exemplary embodiment, before classifying the current operation data, the method may further include: cleaning the current operating data to remove abnormal data.

Specifically, since the current operation data of the turbine device may be a measurement acquired from a sensor element installed in the turbine device, and the sensor element is worn during use, may generate errors due to wear during use, data cleaning is primarily performed to remove abnormal data caused by sensor aging or malfunction. By preprocessing the current operation data, the comprehensiveness and the validity of the operating data can be ensured, thereby forming the preprocessed operation data that can be used for subsequent classification and generation of the sample library.

In S40, a mapping model is constructed based on the combined dataset and an updated performance curve is outputted by the mapping model with the inlet parameter as the design parameter.

As described above, the combined data set is obtained by classifying the current operation data, which reflects the correspondence between the input data and the output data. This step is to construct the mapping model by using the combined data set, and the mapping model outputs an update performance curve adapted to the current operation data. It can be understood that the updated performance curve of the turbine device is obtained by changing the flow rate and the rotational speed under the condition that the design inlet pressure and the inlet temperature are kept constant. The update performance curve may be a curve of flow ratio data-pressure ratio data of the turbine device at different rotational speeds, or may be a curve of flow ratio data-efficiency data of the turbine device at different rotational speeds.

In an exemplary embodiment, the mapping model may be constructed by: training a selected machine learning model using the combined dataset to obtain the mapping model. Input parameters of the mapping model correspond to data types in the input dataset, and output parameters of the mapping model correspond to data types in the output dataset.

Specifically, the machine learning model may include, for example, a decision tree model, a K-N algorithm model, a random forest model or a logistic regression model, etc., and is preferably a decision tree model or a neural network model. After the machine learning model is selected, model training may be performed on the machine learning model by using the combined data set to obtain the mapping model.

Further, the combined data set may be further divided into a training set and a test set, the training set is used for model training to obtain a mapping model, and the test set is used to test the constructed mapping model to detect whether the constructed mapping model meets requirements. On this basis, training the selected machine learning model using the combined dataset to obtain the mapping model includes: training the selected machine learning model using the training set; testing the trained machine learning model using the test set, where the machine learning model outputs corresponding test output data based on input data in the test set; and determining the machine learning model as the mapping model if a test result indicates that an output accuracy of the machine learning model meets a preset condition.

Testing the trained machine learning model by using the test set is to perform precision detection on the trained model, and includes: determining an absolute value of an accuracy error between the test output data and original output data in the test set corresponding to the input data; and comparing the absolute value of the accuracy error with a second preset threshold. The input data and the output data in the test set have a one-to-one correspondence. The original output data is output data in the test set, that is, the original output data set is actual output data of the turbine device. The test output data is data output by the trained model based on the input data in the test data set. This step is intended to input the input data in the test set into the trained model, such that the trained model outputs corresponding data as test output data. The test output data is then compared with the original output data in the test set corresponding to the input data, and the deviation between the original output data and the test output data is used to determine whether the trained model meets an accuracy requirement. If the accuracy requirement is met, the trained model is determined to be the final mapping model. Otherwise, if the accuracy requirement is not met, subsequent steps are performed to retrain the model until a mapping model meeting the accuracy requirement is obtained.

In this exemplary embodiment, the preset condition may be the absolute value of the accuracy error between the test output data and the original output data being less than the second preset threshold. Obviously, if an accuracy error between the test output data and the original output data is less than a second preset threshold, it indicates that the trained model meets the accuracy requirement, and the trained model may be determined as the final mapping model. Conversely, if an absolute value of the accuracy error between the test output data and the corresponding original output data is greater than or equal to the second preset threshold, it indicates that the currently trained model does not meet the accuracy requirement. In this case, a machine learning model may be reelected, and the reselected machine learning model may be trained using the training set and tested using the test set until the test result meets a preset condition. In addition, it should be understood that, when the output accuracy of the machine learning model fails to meet the preset condition, a parameter range and the sample library may also be expanded, and the above model training and testing process may be performed until the required accuracy is achieved.

In this step, the mapping model is obtained through sample learning. Based on the mapping model, a pressure ratio and an efficiency of the turbine device can be obtained for any flow ratio and rotational speed ratio. That is, the mapping model can output an updated performance curve, under design inlet parameters, that matches the current operating characteristics of the turbine device.

In S50, a previous performance curve of the simulation model is replaced with the updated performance curve to evolve the simulation model.

This step is to replace the historical performance curve of the simulation model. Since the updated performance curve is obtained based on the current operating conditions of the turbine device, the updated performance curve is used to replace the historical performance curve in the simulation model.

By replacing the existing historical performance curve of the simulation model with the updated performance curve corresponding to the current operating condition of the turbine device in the current stage, the evolution of the historical performance curve of the simulation model is completed. In this way, the historical performance curve of the simulation model at the current stage can accurately simulate the operating characteristics of the turbine device in the current stage, precisely reflecting the performance of the turbine device after degradation, thereby enabling the simulation model to evolve according to the degree of performance degradation.

According to the embodiments of the present application, the current operation data of the turbine device is acquired firstly, and the current operation data represents the actual operating characteristics of the turbine device in the current state. The current operation data is then divided into an input dataset and an output dataset. The data in the input dataset and data in the output dataset are subsequently combined to generate a combined dataset, the combined dataset is input into a sample library, and a machine learning model is used to perform model training based on the combined dataset in the sample library to generate a mapping model. An updated performance curve is generated by the mapping model, the updated performance curve reflecting the pressure ratio and efficiency of the turbine device under different flow ratio and speed ratio conditions in the current state. Finally, the previous performance curve of the simulation model is replaced with the updated performance curve generated by the mapping model, so that the simulation model can evolve according to the degree of degradation of the turbine device, and truly reflect the operating characteristics of the turbine device at different life cycle stages. The method for evolving a simulation model for a turbine device according to embodiments of the present application solves the problem of reduced simulation accuracy caused by performance degradation throughout the entire service life of the turbine device. It ensures high-precision simulation of the turbine operating characteristics at various stages over its full lifecycle, enabling accurate simulation of behavioral characteristics under different degrees of performance degradation during each operating phase. This method thus represents an effective approach for constructing a digital twin of turbine devices.

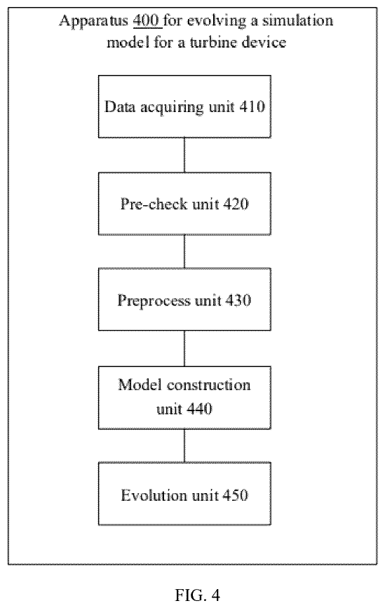

Referring to FIG. 4, based on the foregoing embodiment, the present application further provides an apparatus for evolving a simulation model for a turbine device. The apparatus 400 includes a data acquisition unit 410, a pre-check unit 420, a preprocessing unit 430, a model construction unit 440, and an evolution unit 450.

The data acquiring unit 410 is configured to acquire current operation data of the turbine device with an inlet parameter as a design parameter.

The pre-check unit 420 is configured to pre-check the simulation model based on the current operation data.

The preprocessing unit 430 is configured to preprocess the current operation data to obtain a combined dataset when a result of the pre-check indicates that the simulation model requires evolution, where the combined dataset comprises input data and output data corresponding to the input data.

The model construction unit 440 is configured to construct a mapping model based on the combined dataset and outputting, using the mapping model, an updated performance curve of the turbine device with the inlet parameter as the design parameter.

The evolution unit 450 is configured to evolve the simulation model by replacing a previous performance curve of the simulation model with the updated performance curve.

In an exemplary embodiment, the preprocessing unit 430 may be further configured to: classify the current operation data to obtain an input data set and an output data set, where the input data set includes flow ratio data and rotational speed ratio data, and the output data set includes pressure ratio data and efficiency data; and map data in the input dataset with data in the output dataset to obtain the combined dataset.

In an exemplary embodiment, the combined data set may include a training set and a test set, and the model construction unit 440 may be further configured to: train a selected machine learning model using the combined dataset to obtain the mapping model, where input parameters of the mapping model correspond to data types in the input dataset, and output parameters of the mapping model correspond to data types in the output dataset.

In an exemplary embodiment, the model construction unit 440 may be further configured to: divide the combined data set into a training set and a test set; train the selected machine learning model through the training set; test the trained machine learning model through the test set, where the machine learning model outputs corresponding test output data based on the input data in the test set; and determine the machine learning model as the mapping model if a test result indicates that an output accuracy of the machine learning model meets a preset condition.

In an exemplary embodiment, the model construction unit 440 may be further configured to test the trained machine learning model through the test set by: determining an absolute value of an accuracy error between the test output data and original output data in the test set corresponding to the input data; and comparing the absolute value of the of the accuracy error with a second preset threshold.

In an exemplary embodiment, the preset condition may include: the absolute value of the accuracy error between the test output data and the original output data being less than the second preset threshold.

In an exemplary embodiment, the model construction unit 440 may be further configured to: select a different machine learning model; train the different machine learning model using the training set; and test the trained different machine learning model using the test set, where the selecting to testing are repeated until the test result satisfies the preset condition.

In an exemplary embodiment, the pre-check unit 420 may be further configured to: construct a current operation curve of the turbine device based on the current operation data; compare the current operation curve with the previous performance curve of the simulation model, where the previous performance curve is output by the simulation model; compare a difference between the previous performance curve and the current operation curve with a first preset threshold, where the first preset threshold is determined based on a precision requirement set by a user; determine that the simulation model requires evolution when the difference exceeds the first preset threshold; and determine that the simulation model does not require evolution when the difference is less than or equal to the first preset threshold.

In an exemplary embodiment, the apparatus 400 may further include a data cleaning unit, and the data cleaning unit may be configured to clean the current operating data to remove abnormal data.

It should be understood that the apparatus 400 provided in this exemplary embodiment may perform method described in any of the foregoing embodiments, and correspondingly has the beneficial effects described in any of the foregoing embodiments, and details are not described herein again.

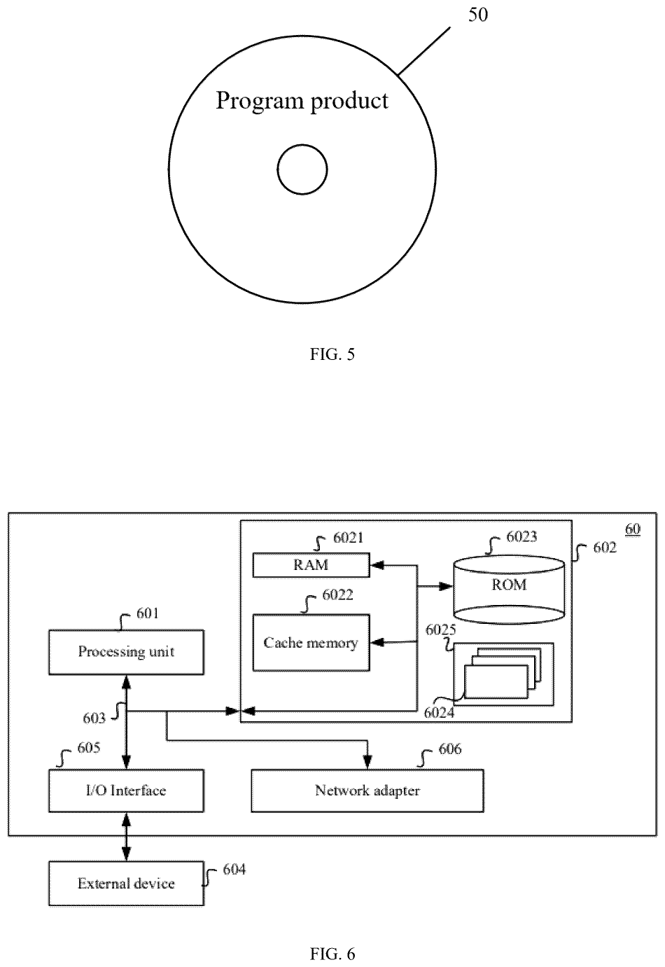

Based on the foregoing embodiments, an embodiment of the present application further provides a computer-readable storage medium, referring to FIG. 5, the computer-readable storage medium shown in FIG. 5 is an optical disk 50, and a computer program (i.e., a program product) is stored on the optical disk 50. The computer program, when executed by a processor, performs the method which includes: acquiring current operation data of the turbine device with an inlet parameter as a design parameter; pre-checking the simulation model based on the current operation data; preprocessing the current operation data to obtain a combined dataset when a result of the pre-check indicates that the simulation model requires evolution, the combined dataset comprising input data and output data corresponding to the input data; constructing a mapping model based on the combined dataset and outputting, using the mapping model, an updated performance curve of the turbine device with the inlet parameter as the design parameter; and replacing a previous performance curve of the simulation model with the updated performance curve to evolve the simulation model. Details of the method are not repeated here.

It should be noted that, examples of the computer-readable storage medium may further include, but are not limited to, a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or other optical and magnetic storage media, and details are not described herein again.

In addition, on the basis of the foregoing embodiments, an embodiment of the present application further provides a computing device, FIG. 6 shows a block diagram of an exemplary computing device 60 adapted to implement the embodiments of the present application, and the computing device 60 may be a computer system or a server. The computing device 60 shown in FIG. 6 is merely an example, and should not impose any limitation on the functions and scope of use of the embodiments of the present application.

As shown in FIG. 6, components of the computing device 60 may include, but are not limited to, one or more processors or processing units 601, a system memory 602, and a bus 603 connected to different system components (including the system memory 602 and the processing unit 601)

The computing device 60 typically includes a variety of computer system readable media. Such media may be any available media that can be accessed by computing device 60, including both volatile and nonvolatile media, removable and non-removable media.

The system memory 602 may include computer system readable media in the form of volatile memory, such as a random access memory (RAM) 6021 and/or a cache memory 6022. The computing device 60 may further include other removable/non-removable, volatile/nonvolatile computer system storage media. By way of example only, the ROM 6023 may be used to read and write non-removable, non-volatile magnetic media (not shown in FIG. 6, commonly referred to as a “hard drive”). Although not shown in FIG. 6, a disk drive for reading from and writing to a removable, non-volatile magnetic disk (e.g., a “floppy disk”), and an optical disk drive for reading from and writing to a removable, non-volatile optical disk (e.g., a CD-ROM, a DVD-ROM, or other optical media) may be provided. In such cases, each driver may be connected to a bus 603 that connects different system components through one or more data media interfaces. The system memory 602 may include at least one program product having a set (e.g., at least one) of program modules configured to perform the functions of embodiments of the present application.

A program/utility 6025 having a set of (at least one) program modules 6024 may be stored, for example, in the system memory 602, and such program modules 6024 include, but are not limited to, an operating system, one or more applications, other program modules, and program data, each of which may include an implementation of a network environment. The program modules 6024 generally perform the functions and/or methods in the embodiments described herein.

The computing device 60 may also communicate with one or more external devices 604 (e.g., keyboards, pointing devices, displays, etc.). Such communication may occur via an input/output (I/O) interface 605. Also, the computing device 60 may communicate with one or more networks, such as a local area network (LAN), a wide area network (WAN), and/or a public network, such as the Internet, through network adapter 606. As shown in FIG. 6, the network adapter 606 communicates with other modules (such as the processing unit 601, etc.) of the computing device 60 by connecting the bus 603 of different system components. It should be understood that although not shown in FIG. 6, other hardware and/or software modules may be used in conjunction with the computing device 60.

The processing unit 601 executes various functional applications and data processing by running the program stored in the system memory 602, for example, acquiring current operation data of the turbine device with an inlet parameter as a design parameter; pre-checking the simulation model based on the current operation data; preprocessing the current operation data to obtain a combined dataset when a result of the pre-check indicates that the simulation model requires evolution, the combined dataset comprising input data and output data corresponding to the input data; constructing a mapping model based on the combined dataset and outputting, using the mapping model, an updated performance curve of the turbine device with the inlet parameter as the design parameter; and replacing a previous performance curve of the simulation model with the updated performance curve to evolve the simulation model. Details of the method are not repeated here. It should be noted that although several units/modules or sub-units/sub-modules of the apparatus are mentioned in the above detailed description, such division is merely exemplary and not mandatory. In fact, according to the embodiments of the present disclosure, the features and functions of the two or more units/modules described above may be embodied in one unit/module. Conversely, the features and functions of one unit/module described above may be further divided into a plurality of units/modules.

In the description of the present application, it should be noted that the terms “first”, “second” and “third” are used for descriptive purposes only and cannot be understood as indicating or implying relative importance.

Those skilled in the art will readily understand that, for the sake of convenience and brevity in description, the specific operation processes of the aforementioned systems, apparatuses, and units may refer to the corresponding processes described in the foregoing method embodiments, and are therefore not repeated herein.

In the several embodiments provided in the present application, it should be understood that the disclosed system, apparatus, and method may be implemented in other manners. The apparatus embodiments described above are merely illustrative, for example, division of the units is merely a logical function division, and there may be another division manner in actual implementation, for example, a plurality of units or components may be combined or may be integrated into another system, or some features may be ignored or not performed. In addition, the displayed or discussed mutual coupling or direct coupling or communication connection may be indirect coupling or communication connection through some communication interfaces, apparatuses or units, and may be in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit.

When the functions are implemented in the form of a software functional unit and sold or used as an independent product, the functions may be stored in a non-volatile computer-readable storage medium executable by a processor. Based on this understanding, the technical solution of the present disclosure essentially or a part contributing to the prior art or a part of the technical solution may be embodied in the form of a software product, and the computer software product is stored in a storage medium, and includes several instructions for causing a computer device (which may be a personal computer, a server, or a network device) to perform all or part of the steps of the method described in the embodiments of the present application. The foregoing storage medium includes any medium that can store program code, such as a USB flash drive, a removable hard disk, a read-only memory (ROM), a random access memory (RAM), a magnetic disk, or an optical disk.

Finally, it should be noted that the above-mentioned embodiments are only specific embodiments of the present application to illustrate the technical solutions of the present application, but not to limit the technical solutions of the present application, and the scope of protection of the present application is not limited thereto. Although the present application has been described in detail with reference to the foregoing embodiments, it should be understood by those skilled in the art that within the technical scope disclosed herein, any person skilled in the art may make modifications or variations to the technical solutions described in the foregoing embodiments, or make equivalent replacements to certain technical features without departing from the spirit and scope of the technical solutions of the present embodiments. Such modifications, variations or substitutions without departing from the spirit and scope of the technical solutions of the embodiments of the present application shall fall within the protection scope of the present application. Therefore, the protection scope of the present application shall be subject to the protection scope of the claims.

In addition, although the operations of the method of the present application are described in a particular order in the accompanying drawings, this does not require or imply that these operations must be performed in that particular order, or that all illustrated operations must be performed to achieve the desired results. Additionally or alternatively, some steps may be omitted, multiple steps may be combined into one step for execution, and/or one step may be divided into multiple steps for execution.

What is claimed is:

1. A method for evolving a simulation model for a turbine device, comprising:
acquiring current operation data of the turbine device with an inlet parameter as a design parameter;
pre-checking the simulation model based on the current operation data;
preprocessing the current operation data to obtain a combined dataset when a result of the pre-check indicates that the simulation model requires evolution, the combined dataset comprising input data and output data corresponding to the input data;
constructing a mapping model based on the combined dataset and outputting, using the mapping model, an updated performance curve of the turbine device with the inlet parameter as the design parameter; and
replacing a previous performance curve of the simulation model with the updated performance curve to evolve the simulation model.

2. The method according to claim 1, wherein the current operation data comprises at least flow ratio data, rotational speed ratio data, pressure ratio data, and efficiency data of the turbine device at a current stage; and wherein the preprocessing the current operation data to obtain a combined dataset comprises:
classifying the current operation data into an input dataset and an output dataset, the input dataset comprising the flow ratio data and the rotational speed ratio data, and the output dataset comprising the pressure ratio data and the efficiency data; and
mapping data in the input dataset with data in the output dataset to obtain the combined dataset.

3. The method according to claim 2, wherein the combined dataset comprises a training set and a test set; and wherein the constructing a mapping model based on the combined dataset comprises:
training a selected machine learning model using the combined dataset to obtain the mapping model, wherein input parameters of the mapping model correspond to data types in the input dataset, and output parameters of the mapping model correspond to data types in the output dataset.

4. The method according to claim 3, wherein the training the selected machine learning model using the combined dataset to obtain the mapping model comprises:
dividing the combined dataset into a training set and a test set;
training the selected machine learning model using the training set;
testing the trained machine learning model using the test set, wherein the machine learning model outputs corresponding test output data based on input data in the test set; and
determining the machine learning model as the mapping model if a test result indicates that an output accuracy of the machine learning model meets a preset condition.

5. The method according to claim 4, wherein the testing the trained machine learning model using the test set comprises:
determining an absolute value of an accuracy error between the test output data and original output data in the test set corresponding to the input data; and
comparing the absolute value of the accuracy error with a second preset threshold.

6. The method according to claim 5, wherein the preset condition comprises the absolute value of the accuracy error between the test output data and the original output data being less than the second preset threshold.

7. The method according to claim 5, wherein, if test result indicates that the output accuracy of the machine learning model does not meet the preset condition, the method further comprises:
selecting a different machine learning model;
training the different machine learning model using the training set; and
testing the trained different machine learning model using the test set, wherein the selecting to testing are repeated until the test result satisfies the preset condition.

8. The method according to claim 1, wherein the pre-checking the simulation model based on the current operation data comprises:
constructing a current operation curve of the turbine device based on the current operation data;
comparing the current operation curve with the previous performance curve of the simulation model;
comparing a difference between the previous performance curve and the current operation curve with a first preset threshold, wherein the first preset threshold is determined based on a precision requirement set by a user;
determining that the simulation model requires evolution when the difference exceeds the first preset threshold; and
determining that the simulation model does not require evolution when the difference is less than or equal to the first preset threshold.

9. The method according to claim 2, wherein before the classifying the current operating data, the method further comprises:
cleaning the current operating data to remove abnormal data.

10. An apparatus for evolving a simulation model for a turbine device, comprising:
a data acquisition unit configured to acquire current operation data of the turbine device with an inlet parameter as a design parameter;
a pre-check unit configured to pre-check the simulation model based on the current operation data;
a preprocessing unit configured to preprocess the current operation data to obtain a combined dataset when a result of the pre-check indicates that the simulation model requires evolution, wherein the combined dataset comprises input data and output data corresponding to the input data;
a model construction unit configured to construct a mapping model based on the combined dataset and outputting, using the mapping model, an updated performance curve of the turbine device with the inlet parameter as the design parameter; and
an evolution unit configured to evolve the simulation model by replacing a previous performance curve of the simulation model with the updated performance curve.

11. A non-transitory computer-readable storage medium storing instructions which, when executed by a computer, cause the computer to perform the method according to claim 1.

12. A computing device, comprising:
at least one processor;
a memory; and
an input/output unit, wherein the memory stores instructions that, when executed by the at least one processor, cause the computing device to perform the method according to claim 1.
